(19) United States
(12) Patent Application Publication
(10) Pub. No.: US 2025/0199503 A1
(43) Pub. Date: Jun. 19, 2025

(54) METHODS AND SYSTEMS FOR IMPROVING RELIABILITY

(71) Applicant: Fluid Power AI, LLC, San Diego, CA (US)

(72) Inventors: Mario Gomez Narvaez, San Diego, CA (US); Brenton Parr Munson, San Diego, CA (US); Francis Mitchell Toglia, San Diego, CA (US); Jose Maria Guadalupe Gomez, San Diego, CA (US)

(21) Appl. No.: 19/063,517

(22) Filed: Feb. 26, 2025

Related U.S. Application Data
(63) Continuation-in-part of application No. 19/040,440, filed on Jan. 29, 2025.
Application No. 19/040,440 is a continuation of application No. 18/542,008, filed on Dec. 15, 2023, now Pat. No. 12,248,296.
Application No. 18/542,008 is a continuation of application No. 18/295,342, filed on Apr. 4, 2023, now Pat. No. 11,880,183.
Application No. 18/295,342 is a continuation of application No. 17/687,116, filed on Mar. 4, 2022, now Pat. No. 11,650,567.
Application No. 17/687,116 is a continuation of application No. 17/182,117, filed on Feb. 22, 2021, now Pat. No. 11,300,942.
Application No. 17/182,117 is a continuation of application No. 16/939,026, filed on Jul. 26, 2020, now Pat. No. 10,962,955.
(60) Provisional application No. 63/560,602, filed on Mar. 1, 2024.
(60) Provisional application No. 62/879,290, filed on Jul. 26, 2019.

(51) Int. Cl. G05B 19/406; G01F 1/10; G01K 13/02; G01L 13/00; G01M 3/02; G06N 20/00

(52) U.S. Cl. CPC G05B 19/406; G01F 1/10; G01K 13/02; G01L 13/00; G01M 3/02; G06N 20/00; G05B 2219/41273

(57) ABSTRACT

Systems and methods for providing reliability as a service (RaaS) are described. A method for providing RaaS, as described, can include providing a mounting interface between a sensor subsystem and an apparatus, thereby coupling the sensor subsystem to the apparatus at a single position; sampling a set of signal streams from the sensor subsystem during operation of the apparatus; returning a set of statuses of a set of subcomponents of the apparatus, upon applying a set of transformations to the set of signal streams, without requiring any disassembly of the apparatus; returning a recommended action for increasing or optimizing reliability of the apparatus based upon a diagnosed status of at least one of the set of subcomponents; and executing the recommended action. The method can be adapted to support monitoring and maintenance of a group of apparatuses.

### CROSS-REFERENCE TO RELATED APPLICATIONS

This application claims the benefit of U.S. Provisional Application No. 63/560,602 filed on 1 Mar. 2024, which is incorporated in its entirety herein by this reference.

This application is also a continuation-in-part of U.S. application Ser. No. 19/040,440 filed on 29 Jan. 2025, which is a continuation of U.S. application Ser. No. 18/542,008 filed on 15 Dec. 2023, which is a continuation of U.S. application Ser. No. 18/295,342 filed on 4 Feb. 2023 and now issued as U.S. Pat. No. 11,880,183 on 23 Jan. 2024, which is a continuation of U.S. application Ser. No. 17/687,116 filed on 4 Mar. 2022 and now issued as U.S. Pat. No. 11,650,567 on 16 May 2023, which is a continuation of U.S. application Ser. No. 17/182,117 filed on 22 Feb. 2021 and now issued as U.S. Pat. No. 11,300,942 on 12 Apr. 2022, which is a continuation of U.S. application Ser. No. 16/939,026 filed on 26 Jul. 2020 and now issued as U.S. Pat. No. 10,962,955 on 30 Mar. 2021, which claims the benefit of U.S. Provisional Application No. 62/879,290 filed on 26 Jul. 2019, each of which is incorporated in its entirety by this reference.

### TECHNICAL FIELD

This invention relates generally to fields related to system monitoring and maintenance, and more specifically to new and useful methods and systems for improving apparatus reliability.

### BACKGROUND

Replacement parts and repair labor contribute to a significant portion of the total maintenance costs of apparatuses (e.g., machines, vehicles, etc.). Reactive maintenance practices have significant and compounding negative effects that result in excess parts and labor expenses. In particular, issues that remain unaddressed, or that are addressed too late, typically lead to failures of multiple apparatus subcomponents, where such multi-component failures could have been prevented by addressing a failure or anticipated failure of the main subcomponent associated with the failure chain.

Furthermore, the technical domain knowledge required to properly troubleshoot and diagnose these complex systems is not readily available to the majority of equipment owners and operators that rely on these systems to produce their core products and services. Without the suitable tools and domain expertise, and when subject to delays caused by part sourcing and/or supply chain issues, failures can result in significant negative impacts. Unexpected downtime and poor system efficiency thus have associated costs that can be prevented or reduced with better monitoring, forecasting and troubleshooting systems. Current solutions for full system monitoring that can diagnose subcomponent issues in apparatus typically use a network of distributed sensors and custom algorithms. Implementing these options requires application-specific domain expertise, and the resources to design, deploy and maintain equipment is typically a non-optimal solution for apparatus owners and operators.

Thus, there is a need in fields related to system monitoring and maintenance, and more specifically, a need for new and useful methods and systems for improving apparatus reliability.

### BRIEF DESCRIPTION OF THE FIGURES

FIG. 1A depicts an embodiment of a method for improving apparatus reliability.

FIG. 1B depicts an embodiment of a method for improving apparatus reliability across a group of apparatuses.

FIG. 2 depicts exemplary apparatus subcomponents subject to non-invasive and real time monitoring according to methods described.

FIG. 3 depicts exemplary model architecture used to generate apparatus subcomponent statuses.

FIG. 4 depicts an exemplary workflow for providing reliability as a service.

FIGS. 5A-5B depict exemplary user interfaces for providing insights into subcomponent statuses, according to a method and system for providing reliability as a service.

FIGS. 6A-6E depict embodiments, variations, and examples of systems including sensor subsystems for providing reliability as a service.

FIG. 7 depicts a computer system configured to provide reliability as a service.

### INCORPORATION BY REFERENCE

All publications, patents, and patent applications mentioned in this specification are herein incorporated by reference in their entireties for all purposes and to the same extent as if each individual publication, patent, or patent application was specifically and individually indicated to be incorporated by reference. Furthermore, where a range of values is provided, it is understood that each intervening value, between the upper and lower limit of that range and any other stated or intervening value in that stated range is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

### 1. Benefits

The inventions associated with the system and method can confer several benefits over conventional systems and methods, and such inventions are further implemented into many practical applications across various disciplines.

In embodiments, the inventions provide reliability as a service (RAAS), by optimizing reductions in apparatus maintenance. Exemplary apparatus types to which the inventions can be applied can include one or more of: hydraulic apparatuses, other apparatuses involving pumps, vehicles (e.g., terrestrial vehicles, aerial vehicles, space craft, watercraft, etc.), power systems, apparatuses with vibrating components, electrical systems, energy infrastructure, other utility infrastructure, battery systems, and/or other apparatus types.

In embodiments, the inventions can optimize reductions in the cost of apparatus maintenance, as enabled by on-board (e.g., edge-deployed) processing systems and architecture that are structured to deliver actionable insights complete with root cause prognostics that can ultimately eliminate existing labor costs associated with troubleshooting. Rapid on-site troubleshooting, in combination with recommendations for addressing issues prior to catastrophic failure, significantly lowers replacement part expenses. As such, the inventions can enable rapid deployment of diagnostics and solutions at the edge (e.g., with edge-deployed computing and sensors), without requiring remote processing of data and non-rapid solutions. As such, the inventions described are structured to provide solutions for repair or replacement of failing subcomponents or subcomponents anticipated to fail, without requiring transmission of signal data to a remote processing system (e.g., a system that is remote from the sensor system and structured with artificial intelligence architecture).

Exemplary outcomes demonstrated by the inventions involved the use of predictive maintenance, enabled by real-time actionable insights, to reduce the annual cost of hydraulic parts and labor by 34% and increase the available maintenance labor force by 7%, in a representative fleet. If this outcome was projected to a situation involving maintenance of a fleet with 100 trucks, there would be over $560K in annual savings and release of up to 3,500 hours of technician time, in comparison with current approaches for hydraulic vehicle fleet maintenance. As such, the inventions provide practical applications involving improved performance (e.g., computational performance) of machines, as well as significant reductions in cost and waste associated with management and maintenance of various system types.

In embodiments, the invention(s) can reduce apparatus maintenance costs by at least 10%, by at least 20%, by at least 25%, by at least 30%, by at least 35%, by at least 40%, or greater, in comparison with existing maintenance costs. In relation to hydraulic vehicle maintenance costs, the invention(s) can anticipate or detect issues with chassis components, hydraulic subcomponents, brake subcomponents, tires, wheels, and/or engine subcomponents, and provide solutions for repairing or replacing such subcomponents efficiently.

In embodiments, the invention(s) can improve speed of detection of subcomponent statuses in a non-invasive manner (e.g., without dismantling apparatuses involving such subcomponents) by at least 50%, by at least 60%, by at least 70%, by at least 80%, by at least 90%, by at least 100%, or greater, in comparison with existing apparatus monitoring systems.

In embodiments, the invention(s) can enable identification of apparatus subcomponents that are past serviceable lives, and that are candidates for replacement. The invention(s) can enable identification of apparatus subcomponents that are within serviceable lives, and provide solutions for efficiently servicing such subcomponents. In embodiments, the invention(s) can include generating diagnostics for serviceable subcomponents, and, if the operator would rather replace certain subcomponents, the invention(s) can involve management of a marketplace for refurbishing serviceable subcomponents that have been relinquished. In one example described here, an apparatus can include a hydraulic refuse truck. A component of the hydraulic refuse truck can include a chassis component, a hydraulic component, a brake component, a tire component, a pump component, an engine component. A subcomponent can include a valve subcomponent. a cylinder subcomponent, or another suitable subcomponent. Exemplary apparatuses, components, and subcomponents across various fields of use are described in more detail below.

In embodiments, the invention(s) can include providing replacement subcomponents (e.g., unlimited replacement subcomponents) to an owner, operator, or maintainer of a group of apparatuses (e.g., at a low fixed cost, according to a subscription model, etc.). In an example, a service plan can provide unlimited, optimally timed replacement components for the group of apparatuses, based upon real-time apparatus monitoring as described. Returned subcomponent statuses notify a platform (e.g., central platform, decentralized platform) when subcomponents are near their efficiency threshold, and automatically delivers replacement subcomponents. The subcomponents that are near their efficiency threshold can then be retrieved for benchmarking and overhaul. Overhauled components can then be stored in inventory (e.g., as in a subcomponent marketplace), and in the future, provided for replacement of other subcomponents that are near their efficiency thresholds. Benefits of the plan include: lower hydraulic parts cost, predictable budgeting, optimization of apparatus performance by providing real-time monitoring and pre-emptive servicing, elimination of troubleshooting labor costs, and improvements to safety and environmental issues (e.g., by ensuring safe operating parameters, elimination of oil spills, elimination of environmental impacts due to proactive maintenance, etc.).

In embodiments, the inventions(s) can be used to provide fleet-wide assessments, such that service solutions account for the fleet as a whole, with the goal of keeping the entire fleet operating as optimally as possible. For example, in one embodiment, the invention(s) can guide harvesting of subcomponents of one vehicle of the fleet to ensure proper operation of the remainder of the fleet, where removing the harvested vehicle from service produces a “greater good” solution that maintains the highest level of performance of the fleet. The invention(s) can thus provide guidance in relation to optimizing distribution of redundant or non-redundant subcomponents across apparatuses of a group of apparatuses (e.g., vehicles of a fleet).

In embodiments, the inventions(s) can be used to provide assessments across multiple units of apparatuses, such that service solutions account for a grouping of units, with the goal of keeping the entire group operating as optimally as possible. For example, in one embodiment, the invention(s) can guide harvesting of subcomponents of one unit to ensure proper operation of the remainder of the group of units, where removing the harvested unit from service produces a “greater good” solution that maintains the highest level of performance of the group of units.

In embodiments, the invention(s) omit requirements to disassemble apparatuses being diagnosed, thereby saving time and costs associated with disassembly and reassembly. Exemplary system components that enable diagnostics to be performed without disassembly and reassembly are described below.

Additionally or alternatively, the invention(s) can confer any other suitable benefit.

### 2. Method—Reliability as a Service

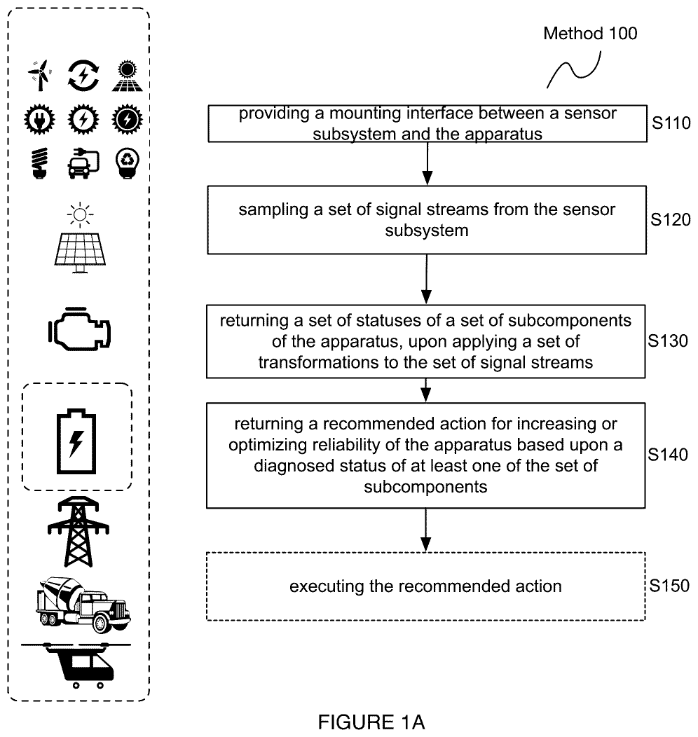

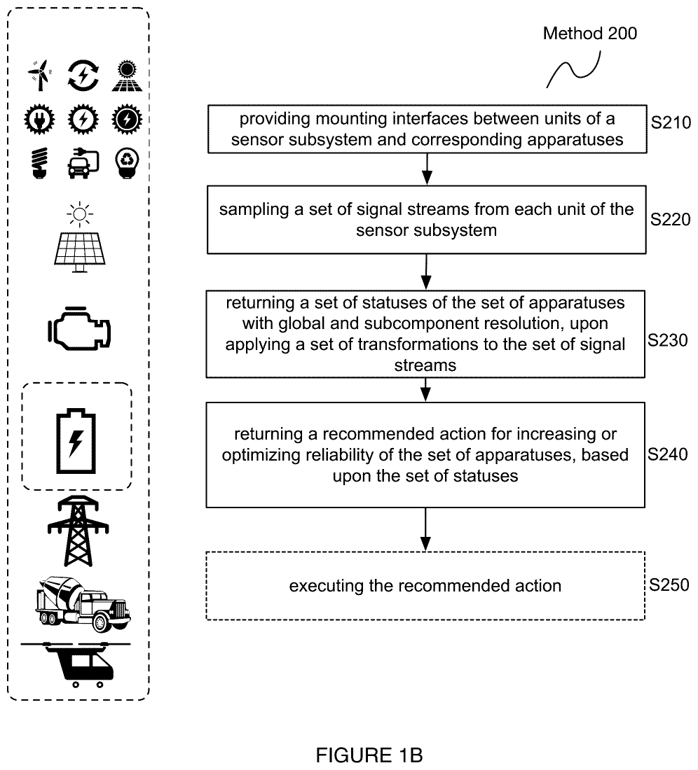

As shown in FIG. 1A, an embodiment of a method 100 for providing reliability as a service includes: For an individual apparatus, providing a mounting interface between a sensor subsystem and the apparatus, thereby coupling the sensor subsystem to the apparatus at a single position Silo; sampling a set of signal streams from the sensor subsystem (e.g., during operation of the apparatus) S120; returning a set of statuses of a set of subcomponents of the apparatus, upon applying a set of transformations to the set of signal streams S130, without requiring any disassembly of the apparatus; returning a recommended action for increasing or optimizing reliability of the apparatus based upon a diagnosed status of at least one of the set of subcomponents S140; and optionally, executing the recommended action S150.

Relatedly, as shown in FIG. 1B, an embodiment of a method 200 for providing reliability as a service includes: For a set of apparatuses, providing mounting interfaces between units of a sensor subsystem and corresponding apparatuses of the set of apparatuses at a single position for each of the set of apparatuses S210; sampling a set of signal streams from each unit of the sensor subsystem (e.g., during operation of the apparatuses) S220; returning a set of statuses of the set of apparatuses with global and subcomponent resolution, upon applying a set of transformations to the set of signal streams S230, without requiring any disassembly of each of the set of apparatuses; returning a recommended action for increasing or optimizing reliability of the set of apparatuses, based upon the set of statuses S240; and optionally, executing the recommended action S250.

The methods 100, 200 function to provide a minimally-invasive approach or non-invasive approach (e.g., using non-contact sensors) to diagnosing apparatuses individually and/or in groups, and to recommend or execute solutions for treating conditions of the apparatuses. The methods 100, 200 can be implemented using embodiments, variations, and examples of system components described in one or more of: U.S. application Ser. No. 16/939,026 filed on 26 Jul. 2020 and now issued as U.S. Pat. No. 10,962,955 on 30 Mar. 2021; U.S. application Ser. No. 18/333,037 filed on 12 Jun. 2023; U.S. application Ser. No. 18/342,525 filed on 27 Jun. 2023; and U.S. application Ser. No. 18/497,913 filed on 27 Jun. 2023, which are each herein incorporated in its entirety by this reference.

### 2.1 Application Areas

In specific examples, the method(s) 100, 200 described can be applied to apparatuses in various industries, in order to provide reliability as a service.

In examples, an apparatus can include one or more of: a vehicle, an electric vehicle, an aerial vehicle (e.g., wherein a subcomponent of the set of subcomponents can include a power plant component, a control surface, a landing subsystem component, a flight instrument, an autonomous flight system component, a delivery subsystem component, a weapons system component, a component associated with a fuel system, a component associated with an oil system, a storage region component, other component), a watercraft (e.g., wherein a subcomponent of the set of subcomponents can include a power plant component, a control surface, a component associated with a fuel system, a component associated with an oil system, a component associated with a sailing subsystem, a weapons subsystem component, a delivery system component, an instrument component, a communications system component, a battery, etc.), another terrestrial vehicle, a drone, a robot, a pump, a battery system, a vibrating component, and any type of apparatus described in further detail below.

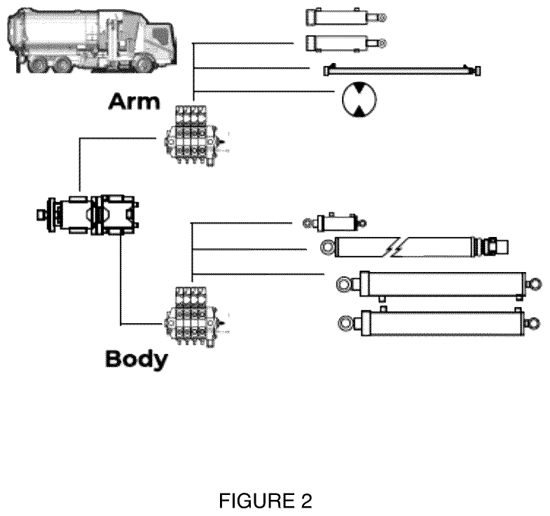

For instance, the method(s) 100, 200 described can be applied to hydraulic equipment (e.g., heavy mobile equipment, such as excavators, oil rig drilling apparatuses, cement trucks, garbage trucks, etc. and/or fixed equipment, such as injection molding machines, overhead cranes, etc.), where maintaining reliability can be based upon monitoring and remediating subcomponents including one or more of: one or more pump subcomponents, a power takeoff (PTO) subcomponent, a valve bank-arm subcomponent, a valve-cartridge subcomponent, a cylinder-arm extend subcomponent, a cylinder-clamp subcomponent, a motor-cart dump subcomponent, a valve bank-body subcomponent, a cylinder-hopper cover subcomponent, a cylinder-dump subcomponent, a cylinder-packer subcomponent, a cylinder-door subcomponent, or another suitable subcomponent, as shown in FIG. 2. In a specific example, the annual hydraulic maintenance cost per hydraulic truck of a fleet can be up to $37K, and implementation of the method(s) described can reduce this cost by percentages indicated above. According to steps S140 and S240 described above, such subcomponent statuses can be monitored without requiring disassembly of the apparatuses, and issues with such subcomponents can be addressed in an efficient manner that does not lead to a cascade of failed subcomponents that would otherwise contribute to unnecessarily high repair and labor resource requirements. Furthermore, reliability optimization can be performed at the fleet level, where solutions may involve reducing reliability (e.g., temporarily reducing reliability) of one or more units of the fleet, in order to globally enhance reliability of performance of the entire fleet.

The method(s) 100, 200 can thus be applied to a fleet (e.g., of vehicles, of aerial vehicles, of drones, of terrestrial vehicles, of watercraft, etc.).

Additionally or alternatively, the method(s) 100, 200 described can be applied to any equipment with a vibrating component. Exemplary equipment include apparatuses with motor components (e.g., shaft components, fan components, rotor components, bearing components, sheave components, cylinder components, piston components, etc.). Subcomponents can also include associated components, such as contaminants, liquids (e.g., oils, etc.), and/or other components. Diagnostics of such apparatuses can include subcomponent evaluations related to a set of harmonic faults of the apparatus, a set of synchronous faults of the apparatus, a set of sub-harmonic and sub-synchronous faults of the apparatus, and a set of non-synchronous faults of the apparatus, where embodiments, variations, and examples of fault statuses are described in U.S. application Ser. No. 18/333,037 filed on 12 Jun. 2023.

Additionally or alternatively, the method(s) 100, 200 described can be applied to any electrical equipment, where electrical equipment subcomponents can include one or more of: electric motors, electric actuators, rotors, stators, bearings, complete printed circuit board assemblies (PCBAs) and systems of PCBAs, fuses, passive components (e.g., capacitors, resistors, diodes, etc.), and active components (integrated chips, etc.). Diagnostics of such apparatuses can include subcomponent evaluations related to short circuit faults, over and under-discharge faults, connector faults, insulation faults, and thermal management faults, while failure modes of the electric motor can include bearing faults, stator faults, and rotator faults, in order to provide improved reliability based upon treatment of such fault situations.

Additionally or alternatively, the method(s) 100, 200 described can be applied to power systems for storing and/or distributing energy. In specific examples, the invention(s) can be applied to monitoring of systems for storing and distributing power, in the context of solar energy systems, solar-thermal energy systems, wind energy systems (e.g., on-shore wind energy systems, off-shore wind energy systems), geothermal energy systems, hydropower energy systems, ocean energy systems, tidal energy systems, biomass energy systems, non-renewable energy source systems, and other power systems.

The method(s) 100, 200 can thus be applied to a group of apparatuses (e.g., units of energy harvesting systems described, etc.).

In the context of solar energy systems, the method(s) 100, 200 described can be applied to subcomponents including one or more of: solar panel components, inverter components, energy storage components, electrical panel components, electric meter components, interfaces to grid components, grid components, and other components in order to provide improved reliability based upon preventative and/or proactive maintenance or replacement of such subcomponents.

In the context of solar-thermal energy systems, the method(s) 100, 200 described can be applied to subcomponents including one or more of: solar panel components, inverter components, electrical panel components, electric meter components, mirror components, receiver components, heat exchanger components, storage tank components, interfaces to grid components, grid components, and other components in order to provide improved reliability based upon preventative and/or proactive maintenance or replacement of such subcomponents.

In the context of wind energy systems (e.g., on-shore wind energy systems, off-shore wind energy systems), the method(s) 100, 200 described can be applied to subcomponents including one or more of: rotor components, nacelle components, tower components, gearbox components, generator components, inverters, foundation components, inter-array cable components, substation components, export cable to onshore interconnection components, interfaces to grid components, grid components, and other components in order to provide improved reliability based upon preventative and/or proactive maintenance or replacement of such subcomponents.

In the context of geothermal energy systems, the method(s) 100, 200 described can be applied to subcomponents including one or more of: heat exchanger components, system pump components, valve components, compressor components, turbine components, generator components, cooling tower components, interfaces to grid components, grid components, and other components in order to provide improved reliability based upon preventative and/or proactive maintenance or replacement of such subcomponents.

In the context of hydropower energy systems, the method(s) 100, 200 described can be applied to subcomponents including one or more of: generator components, transformer components, powerhouse components, turbine components, components associated with intakes from a reservoir, components associated with control gates, components associated with penstock access, transformer components, interfaces to grid components, grid components, and other components in order to provide improved reliability based upon preventative and/or proactive maintenance or replacement of such subcomponents.

In the context of ocean energy and/or tidal systems, the method(s) 100, 200 described can be applied to subcomponents including one or more of: steam condenser components, liquid pump components, vacuum pump components, heat exchanger components, turbine components, turbine tunnel components, sluice gate components, ram joint components, turbine components, interfaces to grid components, grid components, and other components in order to provide improved reliability based upon preventative and/or proactive maintenance or replacement of such subcomponents.

In the context of biomass energy systems, the method(s) 100, 200 described can be applied to subcomponents including one or more of: fuel system components, steam production system components, turbine components, generator components, transformer components, interfaces to grid components, grid components, and other components in order to provide improved reliability based upon preventative and/or proactive maintenance or replacement of such subcomponents.

Other components can include power plant components, transformer components for stepping up voltage, transmission line components, transformer components for stepping down voltage, distribution line components, and/or other components.

In the context of electric vehicles, the method(s) 100, 200 described can be applied to subcomponents including one or more of: energy management system components, battery components, inverter components, electric motor components, drivetrain components, regenerative braking system components, other electric vehicle electrical system components, and/or other components in order to provide improved reliability based upon preventative and/or proactive maintenance or replacement of such subcomponents.

In the context of electric vehicle chargers, the method(s) 100, 200 described can be applied to subcomponents including one or more of: alternating current (AC) supply components (e.g., single phase, 3-phase, fixed supply, etc.), metering and billing components, safety interlock components, components of level 1 and level 2 chargers (e.g., rectifier components, power control unit components, direct current (DC) converter components, protection components, battery monitor components, battery management components, etc.), components of level 3 chargers (e.g., control area network (CAN) bus control and authentication components, protection circuit components, battery monitor components, battery management components, etc.), inverter components (e.g., AC/DC bi-directional inverter components, other vehicle-to-grid charging components, and other components in order to provide improved reliability based upon preventative and/or proactive maintenance or replacement of such subcomponents.

In the context of batteries and/or battery management systems, the method(s) 100, 200 described can be applied to subcomponents including cathode components, anode components, separator components, cells, architecture for coupling batteries in parallel, architecture for coupling batteries in series, electrodes, housings, thermal management/cooling systems, electrolytes, separators, containers/housings, connectors, terminals, protective circuitry, devices incorporating such batteries, and/or other subcomponents in order to provide improved reliability based upon preventative and/or proactive maintenance or replacement of such subcomponents. In a specific use case, the methods 100, 200 can be applied to vehicle batteries (e.g., electric vehicle batteries, hybrid vehicle batteries, non-electric vehicle batteries, etc.), where the batteries can be configured to maintain themselves and/or sell themselves as needed, based upon diagnostics generated according to methods described, and seamless marketplace integration for replacing or repairing subcomponents based upon actual and/or anticipated failures of subcomponents.

With respect to battery manufacture, the method(s) 100, 200 described can be applied monitoring of subcomponents and/or assemblies during stages of manufacturing, including one or more of: raw material preparation; electrode preparation, electrode drying and calendaring; electrolyte preparation; separator coating (e.g., for some battery types); cell assembly; electrolyte filling; sealing; formation and aging; quality testing; module and pack assembly; final testing and inspection; and/or other stages.

### 2.2 Method—Sensor Interfaces

For an individual apparatus, Step S110 recites: providing a mounting interface between a sensor subsystem and the apparatus, thereby coupling the sensor subsystem to the apparatus at a single position; relatedly, Step S210 recites: for a set of apparatuses, providing mounting interfaces between units of a sensor subsystem and corresponding apparatuses of the set of apparatuses at a single position for each of the set of apparatuses. Steps S110 and S210 function to interface sensors (e.g., compact sensors) with apparatuses at single or a small number of relevant positions for detecting signals from the apparatuses, in order to enable on-site diagnostics to be performed, without disassembly of such apparatuses.

Embodiments, variations, and examples of such sensors (e.g., contact sensors, non-contact sensors, etc.), mounting interfaces, and mounting positions are described in one or more of: U.S. application Ser. No. 16/939,026 filed on 26 Jul. 2020 and now issued as U.S. Pat. No. 10,962,955 on 30 Mar. 2021; U.S. application Ser. No. 18/333,037 filed on 12 Jun. 2023; U.S. application Ser. No. 18/342,525 filed on 27 Jun. 2023; and U.S. application Ser. No. 18/497,913 filed on 27 Jun. 2023, which are each incorporated in its entirety by reference above.

Exemplary sensors can include one or more of: flow sensors, pump demand sensors, temperature sensors, pressure sensors, voltage sensors, current sensors, vibration sensors, and auxiliary sensors. In variations, the sensor subsystem can include at least two of: a flow sensor, a pump demand sensor, a temperature sensors, a pressure sensor, a voltage sensor, a current sensor, and a vibration sensor.

### 2.3 Method—Signal Sampling

Step S120 recites: sampling a set of signal streams from the sensor subsystem (e.g., during operation of the apparatus); relatedly, Step S220 recites: sampling a set of signal streams from each unit of the sensor subsystem (e.g., during operation of the apparatuses). Steps S120 and S220 function to monitor a discrete (e.g., minimized) set of signal types and/or number of parameters, from which performance of the apparatuses and/or demand on the apparatus can be extracted. The data derived from the signals can then be processed according to methods described in more detail below, in order to efficiently assess statuses of and/or anticipate events of the apparatus and its subcomponents. Signal resolution and other parameters are described in one or more of: U.S. application Ser. No. 16/939,026 filed on 26 Jul. 2020 and now issued as U.S. Pat. No. 10,962,955 on 30 Mar. 2021; U.S. application Ser. No. 18/333,037 filed on 12 Jun. 2023; U.S. application Ser. No. 18/342,525 filed on 27 Jun. 2023; and U.S. application Ser. No. 18/497,913 filed on 27 Jun. 2023, which are each incorporated in its entirety by reference above.

### 2.4 Method—Signature Extraction and Subcomponent Status Return

Step S130 recites returning a set of statuses of a set of subcomponents of the apparatus, upon applying a set of transformations to the set of signal streams, without requiring any disassembly of the apparatus; relatedly, Step S230 recites: returning a set of statuses of the set of apparatuses with global and subcomponent resolution, upon applying a set of transformations to the set of signal streams. Steps S130 and S230 function to receive, as inputs, the data streams of Steps S120 and S220, respectively, in order enable extraction of signatures corresponding to events (e.g., historical events, anticipated events, usage, etc.) and/or statuses (e.g., health statuses) of the apparatus (e.g., at global and subcomponent levels), in relation to various faults associated with subcomponents and combinations of subcomponents described.

Statuses of subcomponents can then be used to guide interventions and/or treatments for repair or replacement of subcomponents, in order to break a cascade of catastrophic failures, according to subsequent steps of the method.

Exemplary statuses can include one or more subcomponent fault states described in Applications incorporated by reference above.

Exemplary statuses can further include one more of: estimated lives of subcomponents, estimated lives of the apparatus (e.g., with and without replacement of subcomponents with indicated fault states), subcomponents that are anticipated to fail in a cascade of subcomponent failures, subcomponents that are anticipated to fail next if a subcomponent with a fault state is not addressed, estimates of replacement costs for a subcomponent, estimates of repair costs for a subcomponent, estimates of time to replace a subcomponent, estimates of time to repair a subcomponent, and/or other suitable subcomponent statuses.

In examples, life estimates can be generated from conversion models of fault statuses and severities of faults. Life estimates can also be returned from models trained to process input fault states or combinations of fault states of different subcomponents, and to return life estimates. Life estimates can be provided in terms of seconds, minutes, hours, days, months, years, or at any time scale.

In relation to performing transformation operations to derive apparatus statuses, embodiments of processing subsystem components described (e.g., in applications incorporated by reference) can receive and process signal streams at the edge, in relation to edge-deployed devices described. Receiving and processing signals can additionally or alternatively be achieved with use of a wireless or wired connection, using any suitable transmission protocol. Receiving the set of data streams and performing the set of transformation operations can be performed real-time (e.g., with information transfer without significant delay from the time of initial signal generation, thereby enabling rapid responses). Additionally or alternatively, receiving the set of data streams and performing the set of transformation operations can be performed non-real time (e.g., with post-processing delay).

In a specific example, Steps S130 and S230 can involve or be executed by way of an embedded controller comprising a computer comprising circuitry for interfacing with sensors and/or mounting interfaces of, with peripherals for debugging and wireless communication. In the specific example, the computer is an embedded single board computer of the signal conditioning and communications subsystem 130 that implements a Xilinx K26 Kria™ system-on-module (SOM) structured for edge computer vision applications, with artificial intelligence (AI) performance attributed to Zynq MPSoC architecture and architecture configured with various deep learning processing unit (DPU) or neural processing unit (NPU) configurations. Various DPU/NPU configurations (e.g., at 300 Hz) of the signal conditioning and communications subsystem 130 can provide performance of the following, in trillions of operations per second (TOPS): 0.5 TOPS, 0.6 TOPS, 0.7 TOPS, 0.8 TOPS, 0.9 TOPS, 1 TOPS, 1.1 TOPS, 1.2 TOPS, 1.3 TOPS, 1.4 TOPS, 1.5 TOPS, 2 TOPS, 3 TOPS, 4 TOPS, or greater, thereby achieving unprecedented performance with respect to computing operations involving machine learning architecture for such novel sensor configurations for monitoring apparatus.

The signal conditioning and communications subsystem aspects described in the example above (e.g., Kria K26 SOM) supports a full range of data type precisions such as FP32, INT8, binary, and other custom data types, and operations on lower precision data type can consume low power (e.g., less than 0.03 picojoules, less than 0.05 picojoules, less than 1 picojoule, less than 10 picojoules, less than 50 picojoules, or up to 700 picojoules, depending upon operation).

In a specific example, processing subsystem components that extract apparatus statuses from sensor signal streams include an NPU with 1 trillions of operations per second (TOPS) capability with energy use performance of less than 1 picojoule per operation. The NPU can include self-attention time-series transformer architecture comprising an encoder block comprising multi-head attention subarchitecture, described in more detail below. The self-attention time-series transformer architecture of the NPU can omit a decoder block, as described in more detail below. The NPU can be on-chip, for edge deployment applications described. Variations of the processing unit can alternatively include other architecture, as described.

### 2.4.1 Method—Apparatus Status Extraction—Self-Attention Architecture

As introduced above, exemplary model architecture(s) used to return a set of statuses of a single apparatus or group of apparatuses include the following:

Self-attention time-series transformer architecture with masking: Such architecture applies a modified self-attention transformer-based architecture capable of processing multivariate time series data, in order to encode sensor data of the sensors described above, in an unsupervised fashion. In doing so, the measured signal(s) of the apparatus and/or subcomponents described above are embedded into a latent space representation of the temporal dynamics of the system. The latent space embedding is then used to classify failure modes and other health statuses of each apparatus involved.

In examples, model architecture includes a deep neural network to encode the physics of the apparatus(es) by monitoring signals associated with output(s) described, as well as time-series signals of relevant system characteristics such as operational state of the apparatuses (e.g., transportation operational modes, demand operational modes, etc.). The model can thus be used to monitor the overall health of the apparatus(es) at global and subcomponent levels, and predict failure modes of systems subcomponents described.

In more detail, the model applies a modified self-attention transformer based architecture capable of processing multivariate time series data to encode the discrete types of data in an unsupervised fashion. Variations of the architecture can alternatively encode a subset of signal types (e.g., with encoding of reduced subsets of signal types in relation to signal types described, etc.). The modified transformer encoder takes as input training samples, X∈R^{w×m}, which are multivariate time series of length w and m different variables. The training samples (e.g., training dataset) can be acquired from the sensor subsystem described, where the training samples include data streams associated with acquired signals/data streams (e.g., voltage signal streams, current signal streams, temperature signal streams, resistance signal streams, impedance signal streams, and/or auxiliary signal streams, etc.), with labels corresponding to known faults, failure modes, and statuses of the apparatus at global and subcomponent levels. To generate the training dataset(s), apparatuses and subcomponents with undiagnosed/unlabeled faults, failure modes, and statuses can be operated, and sensor signals can be acquired to generate the training dataset, with subsequent verification of classified statuses, with unsupervised multistage training.

The original feature vectors xₜ are first normalized by subtracting the mean and divide by the variance across the samples of the training dataset. The normalized inputs are then linearly projected with bias onto a d-dimensional vector space, where d is the dimension of the transformer model sequence element representations: uₜ=Wₚxₜ+bₚ, where Wₚ∈R^{d×m} and bₚ∈R^{d} are fully learnable parameters and uₜ∈R^{d}, t=0 . . . , w are inputs to the transformer encoder. These inputs, which were transformed from the training dataset, become the queries, keys and values feeding into the self-attention layer, after adding the positional encodings corresponding to time, t_{w}. The multi-headed attention mechanism is altered by changing the normalizations from layer based to batch based, which allows for better handling of outlier signal data, and utilizing a Gaussian error linear unit (GELU) instead of a rectified linear unit (ReLU).

In a standard transformer which employs an encoder-decoder framework, the result of the transformer encoder block is sent along with the target shifted output sequence to the decoder block in a supervised fashion.

Embodiments of the model architecture can implement an alternative approach, with inclusion of architecture for seeking unbiased embedding of the health state of the apparatus(es) involved. The decoder block can be omitted, and instead a single linear layer is used to predict the normalized input values. The degree to which these predicted system values recapitulate the source data allows the model to learn interdependencies between the monitored variables of the system, embed these relationships into a high dimensional state, and predict the state of the apparatus or subcomponents from sparse input data, in a manner that produces a higher level of efficiency with respect to computations performance and energy usage.

The multivariate time-series encoder can be trained in two stages, as indicated above. First, an unsupervised pre-training is performed to autoregress unlabeled time-series data of the training dataset. The goal of the unsupervised training is to encode an input spectrum into a meaningful latent space. The resulting embedding allows both the original spectra to be decoded directly from the latent space representation but also facilitates downstream application for classification and forecasting of failure modes in associated apparatuses. As described above, application-of-use-specific auxiliary sensor data can be processed by the model with unassisted auto regression to embed associated signatures and fine tune application-of-use-specific models.

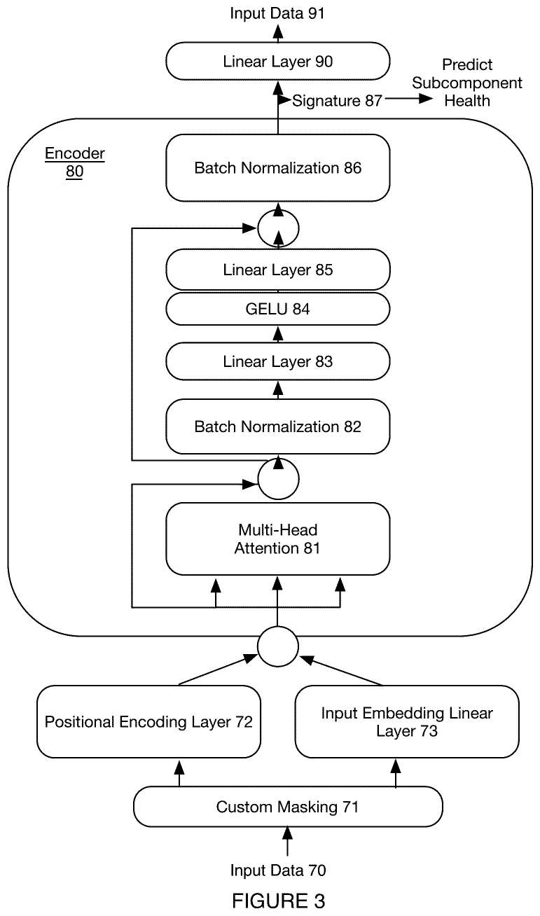

FIG. 3 depicts a schematic of exemplary neural network architecture for the modified attention-based transformer encoder used to autoregress multivariate time series data of one or more signal types described with respect to apparatus subcomponents described. In more detail with respect to model architecture, input data 70 is processed with a custom masking 71, followed by processing with a positional encoding linear layer 72 and an input embedding linear layer 73. Outputs of the positional encoding linear layer 72 and the input embedding linear layer 73 are then processed with an encoder block 80 including multi-head attention subarchitecture 81, followed by first batch normalization architecture 82, a first linear layer 83, a Gaussian error linear unit 84, a second linear layer 85, and second batch normalization architecture 86. Outputs of the encoder block include signature(s) 87, which are returned to a third linear layer 90 to generate second input data 91 (e.g., where autoregression architecture of the model is structured such that input data 91 is attempting to match input data 70, with iterative training).

The exemplary neural network architecture can include Pytorch implementation of a transformer encoder for multivariate time series containing 6 variables with a model dimension of size 128, 8 attention heads, a forward expansion of 4× in the feed-forward block, and a dropout fraction of 0.1 after batch normalization. In variations, the self-attention time-series transformer architecture can be characterized by a forward expansion of: at least 2× in a feed-forward block, at least 3× in a feed-forward block, at least 4× in a feed-forward block, at least 5× in a feed-forward block, at least 6× in a feed-forward block, at least 7× in a feed-forward block, at least 8× in a feed-forward block, at least 9× in a feed-forward block, at least lox in a feed-forward block, or more. In variations, the self-attention time-series transformer architecture can be characterized by: a dropout fraction of less than 0.6, a dropout fraction of less than 0.5, a dropout fraction of less than 0.4, a dropout fraction of less than 0.3, a dropout fraction of less than 0.2, a dropout fraction of less than 0.1, or lower.

In relation to subsystems and equipment described, exemplary failure modes and other statuses that are returned by trained model architecture relate to anticipation of a set of faults including one or more faults described in applications incorporated by reference.

Variations of model architecture are further described in one or more of: U.S. application Ser. No. 16/939,026 filed on 26 Jul. 2020 and now issued as U.S. Pat. No. 10,962,955 on 30 Mar. 2021; U.S. application Ser. No. 18/333,037 filed on 12 Jun. 2023; U.S. application Ser. No. 18/342,525 filed on 27 Jun. 2023; and U.S. application Ser. No. 18/497,913 filed on 27 Jun. 2023, which are each incorporated in its entirety by reference above.

### 2.5 Method—Reliability Recommendations, Therapeutic Interventions, and Optimization for Apparatuses

Step S140 recites: returning a recommended action for increasing or optimizing reliability of the apparatus based upon a diagnosed status of at least one of the set of subcomponents S140, and step S150 recites: optionally, executing the recommended action.

Steps S140 and S150 function to utilize returned statuses (e.g., anticipated or actual fault states) of subcomponents from step S130 to guide and perform actions for improving reliability of the apparatus, as a service. In particular, statuses can describe one or more subcomponent fault states, estimated lives of subcomponents, estimated lives of the apparatus (e.g., with and without replacement of subcomponents with indicated fault states), subcomponents that are anticipated to fail in a cascade of subcomponent failures, subcomponents that are anticipated to fail next if a subcomponent with a fault state is not addressed, estimates of replacement costs for a subcomponent, estimates of repair costs for a subcomponent, estimates of time to replace a subcomponent, estimates of time to repair a subcomponent, and/or other suitable subcomponent statuses.

With identification of subcomponents that are near the ends of their serviceable lives and/or are past serviceable lives (e.g., based upon life estimates described above), recommended and executed actions can include automatically initiating procedures for providing a replacement subcomponent. Providing a replacement subcomponent can be performed with or without the operator or maintainer's input. Providing a replacement subcomponent can be performed with the operator or maintainer's authorization. In an example, Steps S140 and S150 can include generating an edge-deployed set of subcomponent statuses without disassembling the apparatus, and based upon a fault state of a subcomponent status, generating instructions for ordering and delivering a replacement subcomponent.

In an example, returning a recommended action and executing the recommended action can include providing instructions (e.g., via a suitable user interface), for accessing and replacing or repairing a subcomponent with a fault status.

In an example, returning a recommended action and executing the recommended action can include providing control instructions to a robotic device that has functionality for accessing, disassembling, and/or repairing a subcomponent with a fault status.

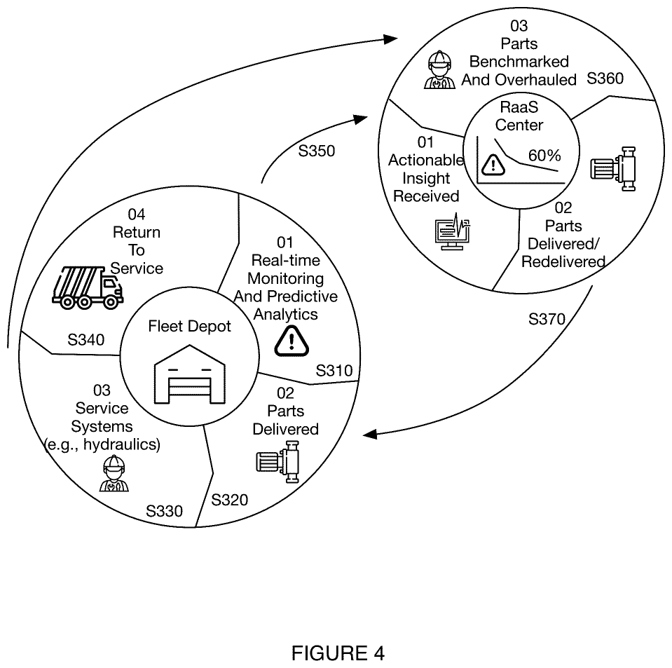

In an example, returning a recommended action and executing the recommended action can include providing replacement subcomponents (e.g., unlimited replacement subcomponents) to an apparatus owner, operator, or maintainer (e.g., at a low fixed cost, according to a subscription model, etc.). In an example, a service plan can provide unlimited, optimally timed replacement components for the apparatus, based upon real-time apparatus monitoring as described. Returned subcomponent statuses notify a platform (e.g., central platform, decentralized platform) when subcomponents are near their efficiency threshold, and automatically delivers replacement subcomponents. The subcomponents that are near their efficiency threshold can then be retrieved for benchmarking and overhaul. Overhauled components can then be stored in inventory (e.g., as in a subcomponent marketplace), and in the future, provided for replacement of other subcomponents that are near their efficiency thresholds. Benefits of the plan include: lower hydraulic parts cost, predictable budgeting, optimization of apparatus performance by providing real-time monitoring and pre-emptive servicing, elimination of troubleshooting labor costs, and improvements to safety and environmental issues (e.g., by ensuring safe operating parameters, elimination of oil spills, elimination of environmental impacts due to proactive maintenance, etc.). An example of a service flow according to Step S150 is shown in FIG. 4.

In the example shown in FIG. 4, returning a recommended action and executing the recommended action can include performing real-time monitoring and predictive analytics S310 according to method steps described above (e.g., involving use of self-attention time series transformer architecture), where Step S310 can be performed for an apparatuses or group of apparatuses (e.g., of a fleet depot); receiving parts for repair or replacement, through an automated delivery platform S320; automatically servicing systems/subcomponents S330 based upon outputs of Step S310; and returning apparatuses to service S340. The automated service and delivery platform (e.g., RaaS center in FIG. 4) can receive outputs of S310 in relation to receiving actionable insights S350; benchmark and overhaul received subcomponents with automated quality control processes S360; and deliver and redeliver subcomponents (e.g., overhauled subcomponents) S370 to operators or maintainers of the apparatus(es). As such, executing the recommended action can include transmitting a subcomponent of the set of subcomponents to an automated service platform, guiding overhaul of the subcomponent at the automated service platform, and automatically delivering the subcomponent, after overhauling the subcomponent, to an operator of the apparatus.

Other recommended actions and execution of recommended actions are provided in Applications incorporated by reference above.

### 2.6 Method—Reliability Recommendations, Therapeutic Interventions, and Optimization for Groups of Apparatuses

Step S240 recites: returning a recommended action for increasing or optimizing reliability of the set of apparatuses, based upon the set of statuses S240, and Step S250 recites: optionally, executing the recommended action.

With identification of subcomponents that are near the ends of their serviceable lives and/or are past serviceable lives (e.g., based upon life estimates described above), recommended and executed actions can include automatically initiating procedures for providing a replacement subcomponent. Providing a replacement subcomponent can be performed with or without the operator or maintainer's input. Providing a replacement subcomponent can be performed with the operator or maintainer's authorization. In an example, Steps S140 and S150 can include generating an edge-deployed set of subcomponent statuses without disassembling the apparatus, and based upon a fault state of a subcomponent status, generating instructions for ordering and delivering a replacement subcomponent.

In an example, returning a recommended action and executing the recommended action can include providing replacement subcomponents (e.g., unlimited replacement subcomponents) to an owner, operator, or maintainer of a group of apparatuses (e.g., at a low fixed cost, according to a subscription model, etc.). In an example, a service plan can provide unlimited, optimally timed replacement components for the group of apparatuses, based upon real-time apparatus monitoring as described. Returned subcomponent statuses notify a platform (e.g., central platform, decentralized platform) when subcomponents are near their efficiency threshold, and automatically delivers replacement subcomponents. The subcomponents that are near their efficiency threshold can then be retrieved for benchmarking and overhaul. Overhauled components can then be stored in inventory (e.g., as in a subcomponent marketplace), and in the future, provided for replacement of other subcomponents that are near their efficiency thresholds. Benefits of the plan include: lower hydraulic parts cost, predictable budgeting, optimization of apparatus performance by providing real-time monitoring and pre-emptive servicing, elimination of troubleshooting labor costs, and improvements to safety and environmental issues (e.g., by ensuring safe operating parameters, elimination of oil spills, elimination of environmental impacts due to proactive maintenance, etc.). An example of a service flow according to Step S250 is shown in FIG. 4.

In some embodiments, where it may take time to deliver a replacement subcomponent, Step S250 can include harvesting or redistributing subcomponents (e.g., based upon subcomponent redundancies) across units of apparatuses of a group, such that executed actions account for the fleet as a whole, with the goal of keeping the entire group of apparatuses operating as optimally as possible. As such, executing the action in Step S250 can include harvesting a subcomponent from a first apparatus of the set of apparatuses and redistributing the subcomponent to a second apparatus of the set of apparatuses based upon subcomponent redundancies across units of apparatuses of the set of apparatuses.

In one scenario, Step S250 can include harvesting of subcomponents of one vehicle of the fleet to ensure proper operation of the remainder of the fleet, where removing the harvested vehicle from service produces a “greater good” solution that maintains the highest level of performance of the fleet. As such, executing the action in Step S250 can include harvesting the subcomponent from the first apparatus ands removing a first vehicle associated with the first apparatus from service in order to improve operational efficiency of the fleet. In another scenario, Step S250 can include removing a redundant subcomponent that is not near its serviceable life from one apparatus, to be installed in another apparatus of a group of apparatuses, to maintain optimal performance across the group of apparatuses. As such, executing the recommended action can include removing a redundant subcomponent from a first apparatus of the set of apparatuses, for installation in a second apparatus of the set of apparatuses while keeping both the first apparatus and the second apparatus in service.

The examples of step S250 described here offer a temporary solution to maintaining operations with the highest performance possible across the group of apparatuses, until replacement subcomponents can be delivered.

In the example shown in FIG. 4, returning a recommended action and executing the recommended action can include performing real-time monitoring and predictive analytics S310 according to method steps described above (e.g., involving use of self-attention time series transformer architecture), where Step S310 can be performed for a group of apparatuses (e.g., of a fleet depot); receiving parts for repair or replacement, through an automated delivery platform S320; automatically servicing systems/subcomponents S330 based upon outputs of Step S310; and returning apparatuses to service S340. The automated service and delivery platform (e.g., RaaS center in FIG. 4) can receive outputs of S310 in relation to receiving actionable insights S350; benchmark and overhaul received subcomponents with automated quality control processes S360; and deliver and redeliver subcomponents (e.g., overhauled subcomponents) S370 to operators or maintainers of the apparatus(es). As such, executing the recommended action can include transmitting a subcomponent of the set of subcomponents to an automated service platform, guiding overhaul of the subcomponent at the automated service platform, and automatically delivering the subcomponent, after overhauling the subcomponent, to the operator(s) and/or other maintainer(s) of the apparatuses.

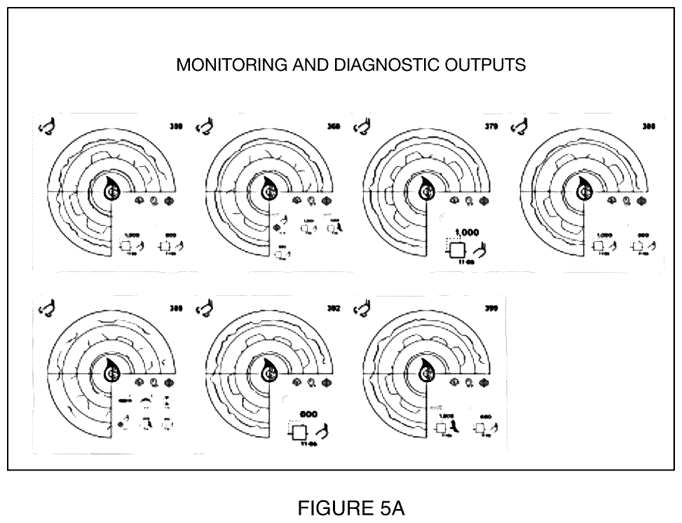

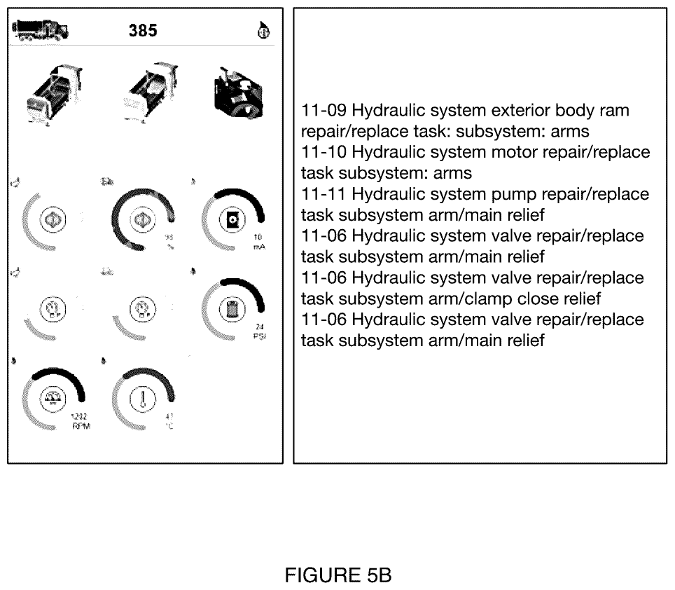

Exemplary interfaces for returning subcomponent statuses are shown in FIGURE SA and FIG. 5B with respect to serviceable lives. Interfaces can also indicate cost optimizations based upon predictive failure mode determinations, and/or provide real-time monitoring.

### 3. System

Embodiments, variations, and examples of system aspects are further described and shown in one or more of: U.S. application Ser. No. 16/939,026 filed on 26 Jul. 2020 and now issued as U.S. Pat. No. 10,962,955 on 30 Mar. 2021; U.S. application Ser. No. 18/333,037 filed on 12 Jun. 2023; U.S. application Ser. No. 18/342,525 filed on 27 Jun. 2023; and U.S. application Ser. No. 18/497,913 filed on 27 Jun. 2023, which are each incorporated in its entirety by reference above.

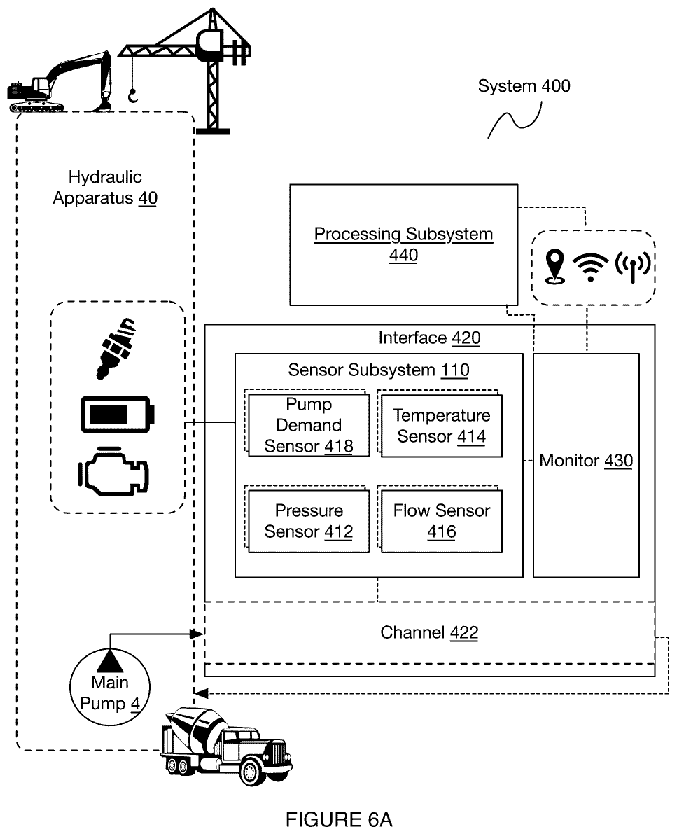

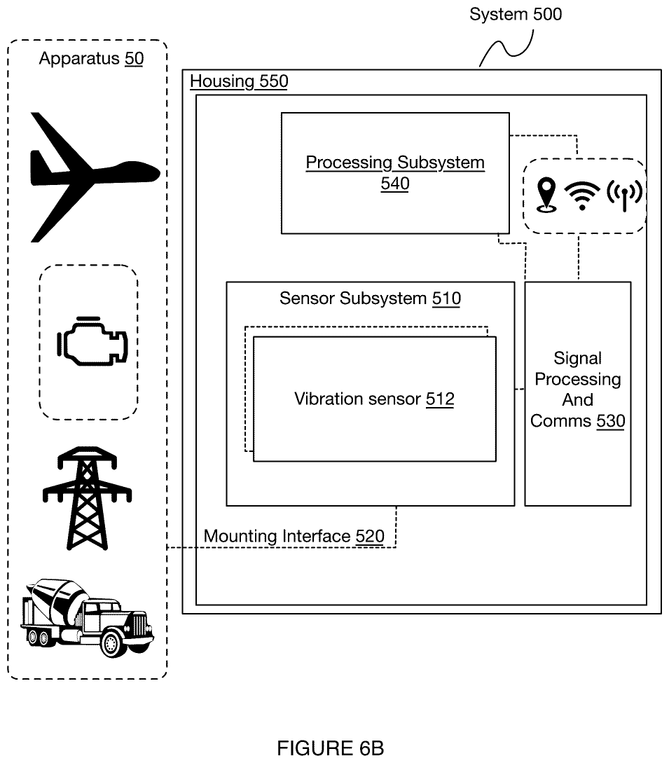

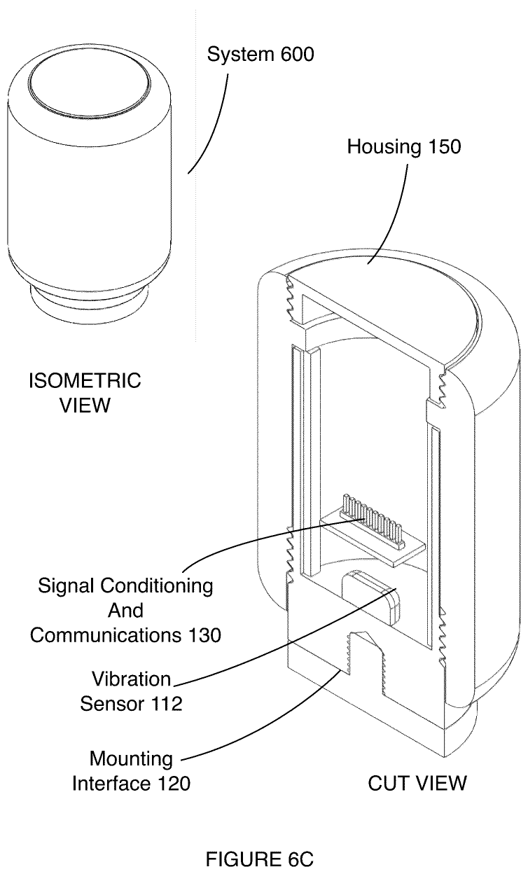

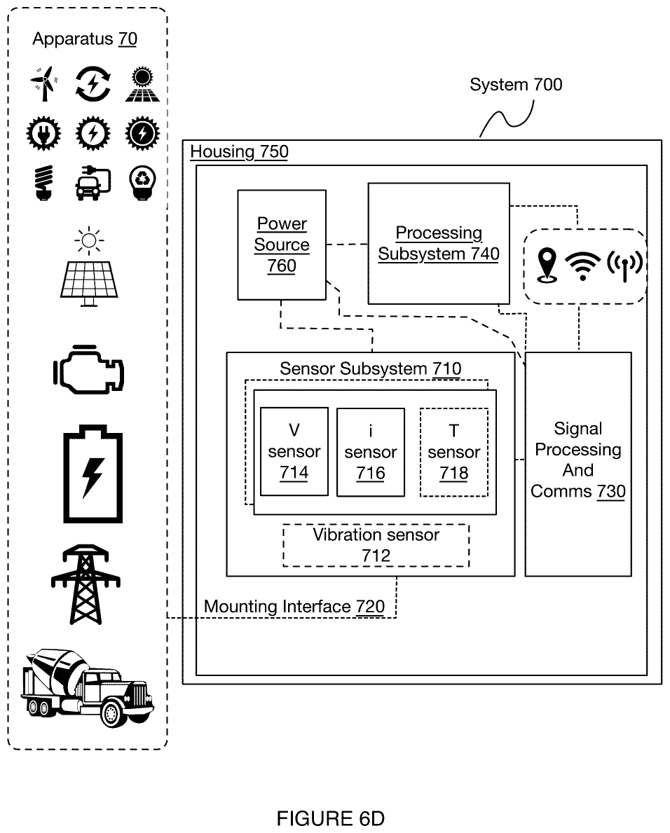

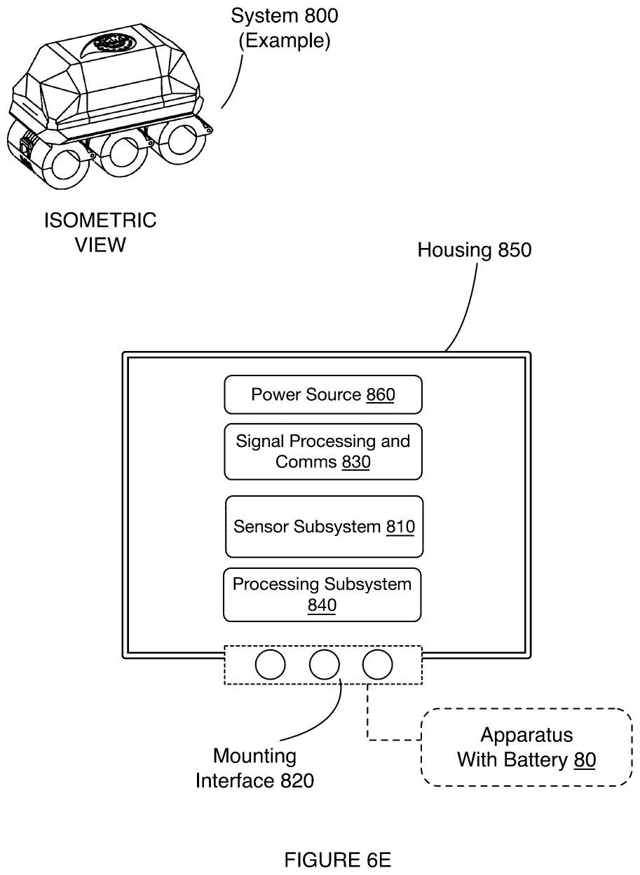

FIG. 6A depicts a first variation of a system 400 used to provide RaaS, where the system 400 includes: a sensor subsystem 410 (e.g., sensor cluster) including one or more of: a pressure sensor 412, a temperature sensor 414, a flow sensor 416, and a pump demand sensor 418; an interface 420 between the sensor subsystem 410 and a hydraulic pump 4 of a hydraulic apparatus 40; a monitor 430 coupled to the sensor subsystem 410 and configured to receive outputs of the sensor subsystem 410; and a processing subsystem 440 operatively coupled to the monitor 430 and including non-transitory media storing instructions that, when executed by the processing subsystem 440, perform operations for identifying, from outputs of the monitor 430/sensor subsystem 410, a set of unique signatures corresponding to states and events of the hydraulic apparatus 40. The set of unique signatures are then used by the processing subsystem 440 to execute actions configured to respond to the states/events appropriately, thereby improving performance of the hydraulic apparatus (e.g., in terms of output, in terms of efficiency, in terms of correcting undesired statuses, in terms of responding to failure modes, etc.).

FIG. 6B depicts a second variation of a system 500 used to provide RaaS, where the system 500 includes: a sensor subsystem 510 (e.g., including a vibration sensor 512); a mounting interface 520 between (e.g., coupling) the sensor subsystem 510 and an apparatus 50; a signal conditioning and communications subsystem 530 coupled to the sensor subsystem 510 and configured to receive outputs of the sensor subsystem 510; and a processing subsystem 540 operatively coupled to the signal conditioning and communications subsystem 530, the processing subsystem 540 including non-transitory media storing instructions that, when executed, perform operations for identifying, from outputs of the signal conditioning and communications subsystem 530/sensor subsystem 510, a set of signatures corresponding to states and events of the apparatus 50. The set of signatures are then used by the processing subsystem 540 to execute actions configured to respond to the states/events appropriately, thereby improving performance of the apparatus (e.g., in terms of output, in terms of efficiency, in terms of correcting undesired statuses, in terms of responding to failure modes, etc.). In variations, identification of signatures corresponding to various states of the apparatus 50 can be achieved with neural network model architecture (e.g., attention-based neural network model architecture); however, other variations of the processing subsystem 540 can implement other model architecture. Embodiments of the system 500 can also include a housing 550 configured to protect the sensor subsystem 510 and the signal conditioning and communications subsystem 530.

FIG. 6C depicts a specific example of a system used to provide RaaS, which is a specific example of the system 500 shown in FIG. 6B.

FIG. 6D depicts a third variation of a system 700 used to provide RaaS, where the system 700 includes: a sensor subsystem 710 (e.g., including voltage sensor 714, current sensor 716, temperature sensor 718, vibration sensor 712, etc.); a mounting interface 720 between (e.g., coupling) the sensor subsystem 710 and an apparatus 70; a signal conditioning and communications subsystem 730 coupled to the sensor subsystem 710 and configured to receive outputs of the sensor subsystem 710; and a processing subsystem 740 operatively coupled to the signal conditioning and communications subsystem 730, the processing subsystem 740 including non-transitory media storing instructions that, when executed, perform operations for identifying, from outputs of the signal conditioning and communications subsystem 730/sensor subsystem 710, a set of signatures corresponding to states and events of the apparatus 70. The set of signatures are then used by the processing subsystem 740 to execute actions configured to respond to the states/events appropriately, thereby improving performance of the apparatus (e.g., in terms of output, in terms of efficiency, in terms of correcting undesired statuses, in terms of responding to failure modes, etc.). In variations, identification of signatures corresponding to various states of the apparatus 70 can be achieved with neural network model architecture (e.g., attention-based neural network model architecture); however, other variations of the processing subsystem 740 can implement other model architecture. Embodiments of the system 700 can also include a housing 750 configured to protect the sensor subsystem 710 and the signal conditioning and communications subsystem 730. Embodiments of the system 700 can additionally include a power source 760.

FIG. 6E depicts an example of a system 800 used for providing RaaS, where the system 800 includes: a sensor subsystem 810; a mounting interface 820 between (e.g., coupling) the sensor subsystem 810 and an apparatus 80 with a battery; a signal conditioning and communications subsystem 830 coupled to the sensor subsystem 810 and configured to receive outputs of the sensor subsystem 810; and a processing subsystem 840 operatively coupled to the signal conditioning and communications subsystem 830, the processing subsystem 840 including non-transitory media storing instructions that, when executed, perform operations for identifying, from outputs of the signal conditioning and communications subsystem 830/sensor subsystem 810, a set of signatures corresponding to states and events of the apparatus 80 with a battery. The set of signatures are then used by the processing subsystem 840 to execute actions configured to respond to the states/events appropriately, thereby enabling detection of fault states of the battery system and/or improving performance of the battery system (e.g., in terms of output and maintenance, in terms of efficiency, in terms of correcting undesired statuses, in terms of responding to failure modes, etc.). In variations, identification of signatures corresponding to various states of the battery system 10 can be achieved with neural network model architecture (e.g., attention-based neural network model architecture); however, other variations of the processing subsystem 140 can implement other model architecture. Embodiments of the system 800 can also include a housing 850 configured to protect the sensor subsystem 810 and the signal conditioning and communications subsystem 830. Embodiments of the system 800 can additionally include a power source 860.

The system embodiment(s) can, however, be configured to implement other workflows including variations of those described, and/or other workflows.

### 4. Computer Systems

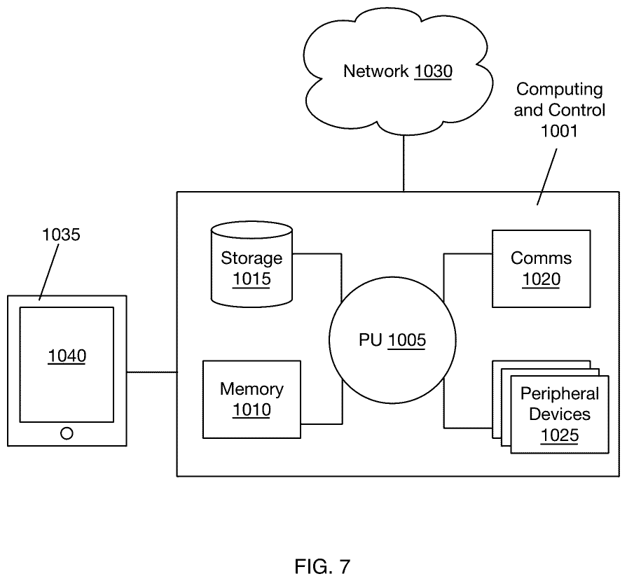

The present disclosure provides computing and control subsystems that are programmed to implement methods associated with the monitoring and prediction devices described, which are configured to provide reliability as a service (RaaS). FIG. 7 shows a computing and control subsystem 1001 that is programmed or otherwise configured to, for example, provide monitoring capabilities for apparatuses described.

The computing and control subsystem 1001 includes architecture for processing and transmitting data (e.g., electrical signal data, temperature data, etc.) detected from said apparatuses.

The computing and control subsystem 1001 can include a processing unit (neural and/or central processing unit) 1005, which can be a single core or multi core processor, or a plurality of processors for parallel processing. The computing and control subsystem 1001 also includes memory or memory location 1010 (e.g., random-access memory, read-only memory, flash memory), electronic storage unit 1015, communication interface 1020 (e.g., network adapter) for communicating with one or more other systems, and peripheral devices 1025, such as cache, other memory, data storage and/or electronic display adapters. The memory 1010, storage unit 1015, interface 1020 and peripheral devices 1025 are in communication with the processing unit 1005 through a communication bus (solid lines), such as a motherboard. The storage unit 1015 can be a data storage unit (or data repository) for storing data. The computer system 1001 can be operatively coupled to a computer network (“network”) 1030 with the aid of the communication interface 1020, but also diagnose and generate outputs on-chip. The network 1030 can be the Internet, an internet and/or extranet, or an intranet and/or extranet that is in communication with the Internet.

In some embodiments, the network 1030 is a telecommunication and/or data network. The network 1030 can include one or more computer servers, which can enable distributed computing, such as cloud computing. For example, one or more computer servers may enable cloud computing over the network 1030 (“the cloud”) to perform various aspects of facilitating charging of an electric vehicle, with desired security, authentication, and locking functionalities associated with various types of charging sessions and/or different users. Such cloud computing may be provided by cloud computing platforms such as, for example, Amazon Web Services (AWS), Microsoft Azure, Google Cloud Platform, and IBM cloud. In some embodiments, the network 1030, with the aid of the computer system 1001, can implement a peer-to-peer network, which may enable devices coupled to the computer system 1001 to behave as a client or a server.

The processing unit 1005 can include one or more computer processors and/or one or more neural processing units (NPUs). The processing unit 1005 can execute a sequence of machine-readable instructions, which can be embodied in a program or software. The instructions may be stored in a memory location, such as the memory 1010. The instructions can be directed to the processing unit 1005, which can subsequently program or otherwise configure the processing unit 1005 to implement methods of the present disclosure. Examples of operations performed by processing unit 1005 can include fetch, decode, execute, and writeback. The processing unit 1005 can be part of a circuit, such as an integrated circuit. One or more other components of the computing and control subsystem 1001 can be included in the circuit. In some embodiments, the circuit is an application specific integrated circuit (ASIC).

The storage unit 1015 can store files, such as drivers, libraries and saved programs. The storage unit 1015 can store user data, e.g., user preferences and user programs. In some embodiments, the computer system 1001 can include one or more additional data storage units that are external to the computer system 1001, such as located on a remote server that is in communication with the computer system 1001 through an intranet or the Internet.

The computing and control subsystem 1001 can communicate with one or more remote computer systems through the network 1030. For instance, the computer system 1001 can communicate with a remote computer system of a user. Examples of remote computer systems include personal computers (e.g., portable PC), slate or tablet PC's (e.g., Apple®iPad, Samsung® Galaxy Tab), telephones, Smart phones (e.g., Apple®iPhone, Android-enabled device, Blackberry®), or personal digital assistants. The user can access the computer system 1001 via the network 1030.

Methods as described herein can be implemented by way of machine (e.g., computer processor) executable code stored on an electronic storage location of the computing and control subsystem 1001, such as, for example, on the memory 1010 or electronic storage unit 1015. The machine executable or machine-readable code can be provided in the form of software. During use, the code can be executed by the processor 1005. The code can be pre-compiled and configured for use with a machine having a processor adapted to execute the code, or can be compiled during runtime. The code can be supplied in a programming language that can be selected to enable the code to execute in a pre-compiled or as-compiled fashion.

Embodiments of the systems and methods provided herein, such as the computing and control subsystem 1001, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, or disk drives, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as the main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computing and control subsystem 1001 can include or be in communication with an electronic display 1035 that comprises a user interface (UI) 540 for providing, for example, a visual display indicative of statuses associated with charging of an electric vehicle, security information, authentication information, and locking statuses associated with various types of charging sessions and/or different users. Examples of UIs include, without limitation, a graphical user interface (GUI) and web-based user interface.

Methods and systems of the present disclosure can be implemented by way of one or more algorithms. An algorithm can be implemented by way of software upon execution by the central processing unit 1005. The algorithm can, for example, facilitate charging of an electric vehicle, with desired security, authentication, and locking functionalities associated with various types of charging sessions and/or different users.

In one set of embodiments, methods implemented by way of or as supported by the computing and control subsystem 1001 can include methods for communication of statuses of subcomponents to another device (e.g., mobile computing device, wearable computing device, other smart device, etc.). Communicated statuses can then be used by the systems described to return notifications (e.g., to an apparatus operator or manager, to another entity) and/or execute other actions pertaining to statuses of the subcomponent(s) of the apparatus(es), where example executed actions can include generation of instructions to control states of the apparatus for safety, or to address faults identified as described above, and/or generation of instructions to control states of the apparatus or perform other recommended actions.

Additionally or alternatively, the computing and control subsystem 1001 can include architecture with programming to execute other suitable methods.

### 5. Conclusions

The FIGURES illustrate the architecture, functionality and operation of possible implementations of systems, methods and computer program products according to preferred embodiments, example configurations, and variations thereof. In this regard, each block in the flowchart or block diagrams may represent a module, segment, or portion of code, which comprises one or more executable instructions for implementing the specified logical function(s). It should also be noted that, in some alternative implementations, the functions noted in the block can occur out of the order noted in the FIGURES. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

As a person skilled in the art will recognize from the previous detailed description and from the figures and claims, modifications and changes can be made to the preferred embodiments of the invention without departing from the scope of this invention defined in the following claims.

What is claimed is:

1. A method comprising:
providing a mounting interface between a sensor subsystem and an apparatus, thereby coupling the sensor subsystem to the apparatus at a single position;
sampling a set of signal streams from the sensor subsystem during operation of the apparatus;
returning a set of statuses of a set of subcomponents of the apparatus, upon applying a set of transformations to the set of signal streams, without requiring any disassembly of the apparatus;
returning a recommended action for increasing or optimizing reliability of the apparatus based upon a diagnosed status of at least one of the set of subcomponents; and
executing the recommended action.

2. The method of claim 1, wherein the apparatus comprises an electric vehicle.

3. The method of claim 1, wherein the apparatus comprises an aerial vehicle, and wherein a subcomponent of the set of subcomponents comprises a power plant component.

4. The method of claim 1, wherein the apparatus comprises a pump.

5. The method of claim 1, wherein the apparatus comprises a battery system.

6. The method of claim 1, wherein the apparatus comprises a vibrating component.

7. The method of claim 1, wherein the sensor subsystem is coupled to a neural processing unit comprising capability for at least 0.5 trillions of operations per second (TOPs).

8. The method of claim 1, wherein applying the set of transformation operations comprises processing the set of signal streams with a model comprising self-attention time-series transformer architecture without a decoder block.

9. The method of claim 8, wherein the set of statuses comprises subcomponent evaluations of a set of harmonic faults of the apparatus.

10. The method of claim 1, wherein executing the action comprises generating instructions for ordering and delivering a replacement subcomponent through an automated delivery platform, based upon generating the set of subcomponent statuses without disassembling the apparatus.

11. The method of claim 1, wherein executing the action comprises transmitting a subcomponent of the set of subcomponents to an automated service platform, guiding overhaul of the subcomponent at the automated service platform, and automatically delivering the subcomponent, after overhauling the subcomponent, to an operator of the apparatus.

12. A method comprising:
for a set of apparatuses, providing mounting interfaces between units of a sensor subsystem and corresponding apparatuses of the set of apparatuses at a single position for each of the set of apparatuses;
sampling a set of signal streams from each unit of the sensor subsystem (e.g., during operation of the apparatuses);
returning a set of statuses of the set of apparatuses with global and subcomponent resolution, upon applying a set of transformations to the set of signal streams, without requiring any disassembly of any of the set of apparatuses;
returning a recommended action for increasing or optimizing reliability of the set of apparatuses, based upon the set of statuses; and
executing the recommended action.

13. The method of claim 12, wherein the set of apparatuses comprises a fleet of vehicles.

14. The method of claim 12, wherein the set of apparatuses comprises a set of energy harvesting systems.

15. The method of claim 12, wherein the sensor subsystem is coupled to an edge-deployed neural processing unit comprising capability for at least 0.5 trillions of operations per second (TOPs).

16. The method of claim 12, wherein applying the set of transformation operations comprises processing the set of signal streams with a model comprising self-attention time-series transformer architecture without a decoder block, the self-attention time-series transformer architecture characterized by a forward expansion of at least 3× in a feed-forward block.

17. The method of claim 12, wherein the sensor subsystem comprises at least two of: a flow sensor, a pump demand sensor, a temperature sensors, a pressure sensor, a voltage sensor, a current sensor, and a vibration sensor.

18. The method of claim 12, wherein executing the recommended action comprises removing a redundant subcomponent from a first apparatus of the set of apparatuses, for installation in a second apparatus of the set of apparatuses while keeping both the first apparatus and the second apparatus in service.

19. The method of claim 12, wherein executing the recommended action comprises harvesting a subcomponent from a first apparatus of the set of apparatuses and redistributing the subcomponent to a second apparatus of the set of apparatuses based upon subcomponent redundancies across units of apparatuses of the set of apparatuses.

20. The method of claim 19, wherein the set of apparatuses comprises a fleet of vehicles, and wherein harvesting the subcomponent from the first apparatus further comprises removing a first vehicle associated with the first apparatus from service in order to improve operational efficiency of the fleet.
